(19) United States
(12) Patent Application Publication
(10) Pub. No.: US 2002/0024379 A1
(43) Pub. Date: Feb. 28, 2002

(54) LOW IMPEDANCE VOLTAGE SOURCE

(76) Inventor: LAURENT SAVELLI, MEYLAN (FR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/353,345

(22) Filed: Jul. 15, 1999

(30) Foreign Application Priority Data
Jul. 17, 1998 (FR) 98/09318

(51) Int. Cl. G05F 1/10

(52) U.S. Cl. 327/541

(57) ABSTRACT

The present invention relates to a low impedance voltage source, including a first N-channel MOS transistor connected between a supply terminal and an output terminal, a second P-channel MOS transistor connected between the output terminal and a ground terminal, and a series circuit including a third diode-connected N-channel MOS transistor, a fourth diode-connected P-channel MOS transistor, a first current source connected between the supply terminal and a gate of the first transistor, and a second current source connected between the ground terminal and a gate of the second transistor, in which a well and a source of the fourth transistor are interconnected, the fourth transistor is connected to the first current source, and the third transistor is connected between the second current source and the fourth transistor.

### TECHNICAL FIELD

The present invention relates to a voltage source, and more specifically to a low impedance voltage source for an integrated circuit.

### BACKGROUND OF THE INVENTION

A low impedance voltage source has many applications in an integrated circuit, for example in a dynamic random access memory (DRAM) for precharging memory bit lines to a predetermined voltage.

FIG. 1 shows a conventional voltage source 1 in MOS technology. This voltage source 1 includes a power stage 2 and a control stage 3. The power stage 2 includes an N-channel MOS transistor T1, the drain D of which is connected to a supply voltage terminal Vdd and the source S of which is connected to an output terminal O, and a P-channel MOS transistor T2, the source S of which is connected to the output terminal O and the drain D of which is grounded.

The control stage 3 includes a first current source R1 connected between the supply voltage Vdd and a diode-connected N-channel MOS transistor T3. A P-channel MOS transistor T4 is diode connected between the transistor T3 and the ground via a current source R2. The drain of the transistor T3 is connected to the gate of the transistor T1 of the power stage 2 and the drain of the transistor T4 is connected to the gate of the transistor T2.

Generally, the substrate of the N-channel transistors, and thus of transistors T1 and T3, is the substrate of the integrated circuit and is grounded. Further, wells of the transistors T2 and T4 are generally connected to the supply voltage Vdd.

A voltage source of the type in FIG. 1 is generally used to provide half of the supply voltage Vdd at low impedance, especially for precharging the bit lines of the DRAM cells. In this case, the current sources R1 and R2 are resistors of the same value R.

A voltage Vo on the output terminal O of the circuit settles at the voltage V present between the transistors T3 and T4. Indeed, the transistors T3 and T4 are run through by a same current I which determines their gate-source voltages Vt3 and Vt4. The sum voltage Vₜ₃+Vₜ₄ is applied between the gates of the transistors T1 and T2. If the transistors T1 and T2 are identical to the transistors T3 and T4, respectively, the gate-source voltage Vₜ₁ of the transistor T1 settles at Vₜ₃ while the gate-source voltage Vₜ₂ of the transistor T2 settles at Vₜ₄, so that the transistors T1 and T2 operate in the same conditions as the transistors T3 and T4 and let through the same current I. As a result, Vo=V.

If a load has a tendency to draw the voltage Vo to the ground, the gate-source voltage Vₜₗ of the transistor T1 increases. The transistor T1 becomes more conductive and tends to maintain the voltage Vo at its original value. The transistor T2 reacts in the same way if a load tends to draw the voltage Vo towards the voltage Vdd.

It should be noted that, even if no load is connected to the output terminal O, the power stage 2 is run through by a current equal to the current I of the control stage 3. In fact, the transistors T1, T2 of the power stage 2 are generally larger than those of the control stage 3, since they have to provide relatively high currents to the load. As a result, the quiescent current of the power stage 2 is a multiple of the quiescent current of the control stage 3, with the multiple equal to a surface ratio of the transistors T1, T2 of the power stage 2 and of the transistors T3, T4 of the control stage 3. Such a current consumption may be impairing in many circuits, especially in dynamic memory circuits in which the conservation of stored data as well as circuit operation are ensured by a battery.

### SUMMARY OF THE INVENTION

An advantage of the present invention is to provide a low impedance voltage source, a power stage of which has a null consumption when is it not connected to any load.

An embodiment of the present invention provides a low impedance voltage source, including a first N-channel MOS transistor connected between a supply terminal and an output terminal, a second P-channel MOS transistor connected between the output terminal and a ground terminal, and a series circuit including a third diode-connected N-channel MOS transistor, a fourth diode-connected P-channel MOS transistor, a first current source connected between the supply terminal and a gate of the first transistor, and a second current source connected between the ground terminal and a gate of the second transistor, in which a well and a source of the fourth transistor are interconnected, the fourth transistor is connected to the first current source, and the third transistor is connected between the second current source and the fourth transistor.

According to an embodiment of the present invention, substrates of the first and third transistors are grounded, and a well of the second transistor is connected to the supply terminal.

According to an embodiment of the present invention, the two current sources comprise equal resistors, and sizes of the transistors are selected for an output voltage to be substantially equal to half a reference voltage.

The foregoing features and advantages of embodiments of the present invention will be discussed in detail in the following non-limiting description of specific embodiments in connection with the accompanying drawings.

### BRIEF DESCRIPTION OF THE DRAWINGS

FIG. 1, previously described, shows a conventional low impedance voltage source.

FIG. 2 shows an embodiment of a low impedance voltage source according to the present invention.

### DETAILED DESCRIPTION OF THE ILLUSTRATED EMBODIMENTS

An embodiment of the present invention provides a low impedance current source including a power stage, transistors of which are controlled so that they are not on when the power stage output voltage remains within a predetermined range around a quiescent voltage.

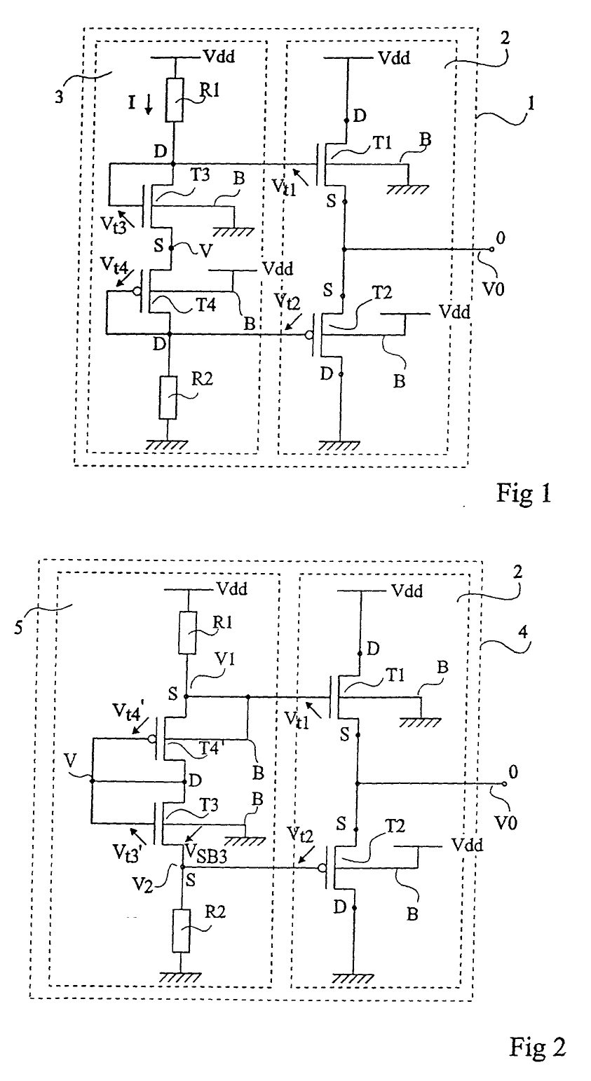

FIG. 2 shows a voltage source 4 which includes a power circuit 2 and a control circuit 5. The power circuit 2 is similar to that described in relation with FIG. 1.

A difference between the control circuit 5 of FIG. 2 and the control circuit 3 of FIG. 1 is that the N-channel MOS transistor T3 and the P-channel MOS transistor T4 have been interchanged. The P-channel MOS transistor of the control circuit 5 here is designated with reference T4′. According to an aspect of the present invention, a well B of the transistor T4′ is connected to its source S.

Calling V1 a control voltage of the transistor T1, generated at the level of the source S of the transistor T4′, one has:

V1=Vdd/2+V_{t4′}/2+V_{t3′}/2 (1)

where V_{t4′} is a threshold voltage of the transistor T4′ and V_{t3′} is a threshold voltage of the transistor T3 (it is assumed herein, for simplification, that the gate-source voltages of the conducting transistors are equal to the threshold voltages of the transistors).

Similarly, calling V2 a control voltage of the transistor T2, generated at the level of the source of the transistor T3, one has:

V2=Vdd/2−V_{t4′}/2−V_{t3′}/2 (2).

There results from the above equation (1) that if the transistor T1 is on, a voltage Vo1 at the level of output terminal O is such that:

Vo1=Vdd/2+V_{t4′}/2+V_{t3′}/2−Vₜ₁ (3).

Similarly, there results from the above equation (2) that if the transistor T2 is on, a voltage Vo2 is such that:

Vo2=Vdd/2−V₄′/2−Vₜ₃′/2+Vₜ₂ (4).

It is known that the threshold voltage of a MOS transistor decreases with a voltage V_{SB} between the source and the substrate or well of a transistor.

The well B and the source S of the transistor T4′ being interconnected, the voltage V_{SB} of the transistor T4′ is null, and as a result, its threshold voltage Vₜ₄′ is much smaller than the voltage Vₜ₄ of FIG. 1.

The substrate B of the transistor T3 is grounded, as in FIG. 1. However, the source of the transistor T3 remains connected to the resistor R2 and its potential is reduced, with respect to FIG. 1, by the gate-source voltage of the transistor T4. As a result, a voltage V_{SB3} of the transistor T3 here is smaller than in FIG. 1, and its threshold voltage V_{t3′} thus also is smaller.

In FIG. 1: Vₜ₃=Vₜ₁ and Vₜ₄=Vₜ₂, with the value Vₜ₃ being slightly different from the value Vₜ₄. The threshold voltages V_{t3′} and V_{t4′} are thus smaller than the threshold voltages Vₜ₁ and Vₜ₂. Vo1<Vdd/2 may be deduced from equation (3), which means that the transistor T1 is on only when the output voltage Vo is smaller than Vdd/2. Similarly, Vo2>Vdd/2 may be deduced from equation (4), which means that transistor T2 is on only when the output voltage Vo is greater than Vdd/2. When the voltage Vo is in the vicinity of Vdd/2 because no load requires any current, neither the transistor T1 nor the transistor T2 are on, and the stage does not consume any current.

In reality, a transistor starts progressively conducting when its gate-source voltage comes near its threshold voltage. Thus, the transistors T1 and T2 conduct for values substantially closer to Vdd/2 than values Vo1 and Vo2. An absence of conduction is achieved for Vo=Vdd/2 due to a combination of an interchanging of the transistors T3 and T4 and of the well-source interconnection of the transistor T4′. As an example, for a voltage Vdd equal to 2.5 volts, the circuit of FIG. 2 enables obtaining voltages Vₜ₁ and Vₜ₂ of 1 volt, a voltage V_{t4′} of 0.63 volts, and a voltage V_{t3′} of 0.73 volts. In such conditions, there actually is an interval of some ten millivolts around value Vdd/2 in which none of the two transistors T1, T2 of the power stage 2 conducts.

Such a circuit is particularly well adapted to dynamic memories in which current consumption has to be limited at all costs, for example, when conservation of stored data as well as circuit operation are ensured by a battery.

Of course, embodiments of the present invention described herein are likely to have various alterations, modifications, and improvements which will readily occur to those skilled in the art. For example, the current sources R1 and R2 may comprise resistors, or any other type of current source.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims, which are to be construed in accordance with established doctrines of claim interpretation.

What is claimed is:

1. A low impedance voltage source, comprising:
a first N-channel MOS transistor connected between a supply terminal and an output terminal;
a second P-channel MOS transistor connected between the output terminal and a ground terminal; and
a series circuit comprising:
a third diode-connected N-channel MOS transistor;
a fourth diode-connected P-channel MOS transistor;
a first current source connected between the supply terminal and a gate of the first transistor; and
a second current source connected between the ground terminal and a gate of the second transistor, wherein:
a well and a source of the fourth transistor are interconnected;
the fourth transistor is connected to the first current source; and
the third transistor is connected between the second current source and the fourth transistor.

2. The low impedance voltage source of claim 1 wherein substrates of the first and third transistors are grounded, and a well of the second transistor is connected to the supply terminal.

3. The low impedance voltage source of claim 1 wherein the two current sources comprise equal resistors and sizes of the transistors are selected for an output voltage to be substantially equal to half a reference voltage.

4. The low impedance voltage source of claim 1 wherein the first transistor is on only when an output voltage is smaller than substantially half of a reference voltage.

5. The low impedance voltage source of claim 1 wherein the second transistor is on only when an output voltage is greater than substantially half of a reference voltage.

6. The low impedance voltage source of claim 1 wherein a control voltage of the first transistor comprise a sum of one-half a reference voltage, one-half a gate-source voltage of the fourth transistor, and one-half a gate-source voltage of the third transistor.

7. The low impedance voltage source of claim 1 wherein a control voltage of the second transistor comprise one-half a reference voltage less one-half a gate-source voltage of the fourth transistor less one-half a gate-source voltage of the third transistor.

8. The low impedance voltage source of claim 1 wherein threshold voltages of the third and fourth transistor are smaller than threshold voltages of the first and second transistors.

9. A low impedance voltage source, comprising:
a power stage coupled to a power supply terminal; and
a control stage coupled to the power stage, wherein the control stage comprises an N-channel MOS transistor, a P-channel MOS transistor, a first current source connected to the P-channel MOS transistor between the power supply terminal and a source of the P-channel MOS transistor, and a second current source connected between a ground terminal and a source of the N-channel MOS transistor, wherein a well and the source of the P-channel MOS transistor are interconnected and the N-channel MOS transistor is connected between the second current source and the P-channel MOS transistor.

10. The low impedance voltage source of claim 9 wherein a substrate of the N-channel MOS transistor is connected to the ground terminal.

11. The low impedance voltage source of claim 9 wherein the two current sources comprise equal resistors and sizes of the transistors are selected for an output voltage to be substantially equal to half a reference voltage.

12. The low impedance voltage source of claim 9 wherein the power stage comprises an N-channel MOS transistor connected between the supply terminal and an output terminal, wherein the N-channel MOS transistor of the power stage is on only when an output voltage is smaller than substantially half a reference voltage.

13. The low impedance voltage source of claim 9 wherein the power stage comprises a P-channel MOS transistor connected between the ground terminal and an output terminal, wherein the P-channel MOS transistor of the power stage is on only when an output voltage is greater than substantially half a reference voltage.

14. A method to provide a voltage source for an integrated circuit, comprising:
connecting first and second transistors of a power stage to a power supply having a reference voltage;
turning the first transistor on if an output voltage is smaller than substantially half the reference voltage or turning the second transistor on if the output voltage is larger than substantially half the reference voltage; and
reducing current in the power stage if the output voltage is substantially equal to half the reference voltage.

15. The method of claim 14 wherein reducing current in the power stage comprises keeping the first and second transistors turned off.

16. The method of claim 14, further comprising connecting a control stage to the power stage and providing the control stage with third and fourth transistors having threshold voltages smaller than threshold voltages of the first and second transistors.

17. The method of claim 14, further comprising limiting current consumption in a memory circuit coupleable to the voltage source.
